(19) United States
(12) Patent Application Publication
(10) Pub. No.: US 2004/0259570 A1
(43) Pub. Date: Dec. 23, 2004

(54) Identifying a base station serving a mobile station

(76) Inventors: Shaoning Wan, Lisle, IL (US); ZhongJin Yang, Naperville, IL (US); Jie Yao, Naperville, IL (US)

Correspondence Address: Werner Ulrich, 434 Maple St, Glen Ellyn, IL, 60137, US

(21) Appl. No.: 10/601,899

(22) Filed: Jun. 23, 2003

(51) Int. Cl. H04Q 7/20

(52) U.S. Cl. 455/456.1

(57) ABSTRACT

A method and apparatus for determining the base station and sector serving a target mobile station. A client makes a request to locate a target mobile station. A server connected to the client determines whether the client is authorized to make this request. If so, the server sends a request to the mobile network to determine the base station and sector currently serving the target mobile station. The mobile network returns information identifying the country, carrier, vendor, and region of the switch serving the mobile station. The server then queries a centralized database to translate between the non-standard format data identifying the base station and sector and a geographic location of that base station and sector. Advantageously, the arrangement is much less expensive than arrangements which seek to determine an exact location of the mobile station.

### TECHNICAL FIELD

This invention relates to arrangements for determining the identity of a base station serving a mobile station.

### BACKGROUND OF THE INVENTION

In cellular wireless systems, a mobile station is connected to a telecommunications network via radio transceivers mounted, usually in a plurality of sectors, in base stations. Each base station serves a geographic area known as a cell; when mobile stations move from cell to cell or from one sector of a cell to another they are handed off from one base station or sector to another.

The base stations are connected to a switch which has overall control of the connection process and which serves as a gateway to a telecommunications network.

In cellular systems, a need frequently arises for locating a mobile station. The most obvious example is for the case of an emergency wherein for example, the mobile station dials 911 and pleads for help against a stalker. In the United States there is a requirement that a mobile station be located within a relatively small distance of its actual location. There are two main methods available for so locating the mobile: a global satellite positioning system at a mobile station can easily identify a location of the mobile station within less than 10 meters. This requires that the mobile station be equipped with a global positioning satellite receiver and processor. For locating a mobile station not so equipped, three or more base stations equipped with means for measuring the delay for signals sent to and received from the mobile station can derive measurements which when properly processed can identify the location of the mobile station within 100 meters. Both of these schemes are expensive. Mobile stations and base stations are equipped to carry out such functions only if there is a government requirement or if the mobile station owner wishes to have the capability of making an accurate location determination.

There are many situations in which it is not necessary to have such an accurate location determination and further wherein the determination of the location is not necessarily at the request of the mobile station user. For examples an employer may wish to have the ability to locate an employee approximately, probably subject to some kind of an agreement between the employer and the employee. For other cases, a government agency may wish to locate a mobile station user approximately without requiring an exact location. A problem of the prior art is that there is no inexpensive way of providing this location.

### SUMMARY OF THE INVENTION

Applicants have carefully studied this problem and have recognized that for many of the needs for locating user of a mobile station, it is adequate to identify the base station and sector being used for communicating with the base station. However, the data for identifying the base station and sector is different in systems of different countries, different vendors, different carriers, and different regions. Applicants have solved this problem by providing a centralized database for translating between the data for identifying the cell and sector, provided by the serving cellular switch, and the geographic location corresponding to that data.

In accordance with one feature of Applicants' invention, a check is made to make sure that the requester has the authority to determine the location of the mobile station.

### BRIEF DESCRIPTION OF THE DRAWING(S)

FIG. 1 is an overall block diagram of the operation of Applicants' invention;

FIGS. 2 and 3 are block diagrams of a centralized database and a server both shown in FIG. 1; and

FIG. 4 is a flow diagram illustrating the operation of Applicants' invention.

### DETAILED DESCRIPTION

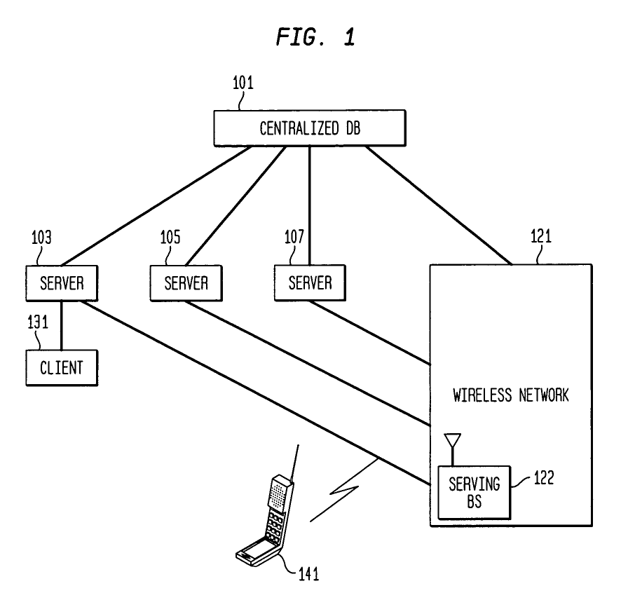

FIG. 1 is a block diagram illustrating the operation of Applicants' invention. A client unit 131 sends a request to a server 103 for determining the location of a mobile station 141. The server sends this request to the wireless network 121 which responds with a message identifying a cell and sector of a base station 122 and providing the information necessary for interpreting the coded cell and sector identification. This latter information includes the country where the mobile station is to be found, the identity of the vendor of the equipment (i.e., the switch) which identified that base station, the identity of the carrier serving the mobile station, and the identity of a region if that carrier serves several regions in one country. This information is returned to the server which passes the information for identifying the base station and sector and the information for interpreting this identification to a centralized database 101. The centralized database returns to the server an identification of the geographic location of the base station and sector serving the target mobile station. This information is then passed from the server 103 to client 131.

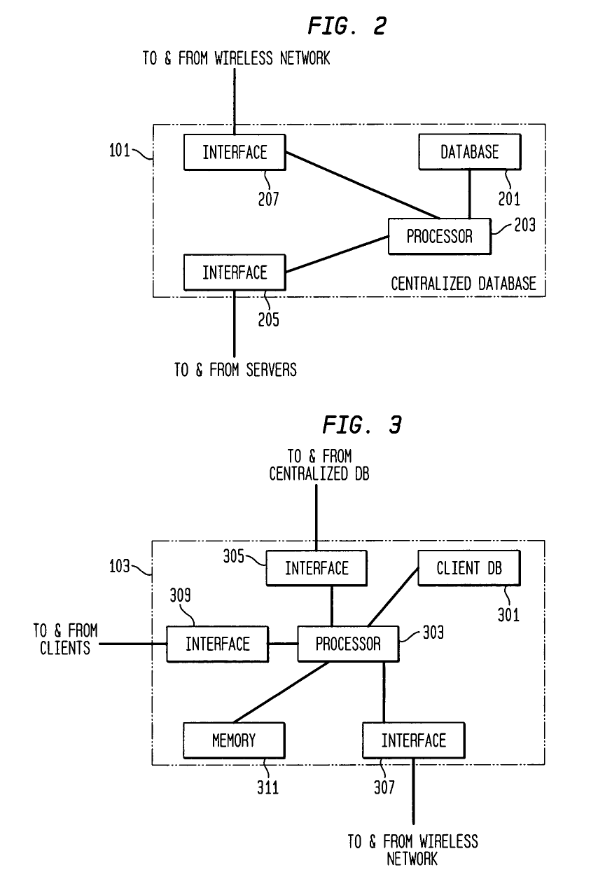

FIG. 2 is an expansion of block 101, the centralized database. The core of the database is a processor 203 and the memory of a database 201. An interface 205 is used between the servers and the centralized database to accept messages from the servers and transmit messages to the servers. The processor 203 receives these messages and uses the data therein to access database 201. One table can be used to translate from country, vendor, carrier and region, to a format type. Given the format type, the cell and sector number can be extracted from the message. Then, another table can be used to translate from the cell and sector to a geographic location, e.g., latitude and longitude. The processor then processes the answers from the database and uses these answers to return a message to the requesting server.

The Interface 207 can be used to receive updates for the database from an administrative bureau; such updates are required whenever a cell or sector is added or deleted.

FIG. 3 is a block diagram illustrating the server 103. The server has an interface 309 for receiving messages from clients (i.e., the entities requesting the location of the target mobile station) and the responses for identifying this location. These messages are then sent to processor 303 and stored in memory 311. Processor 303 then queries client database 301 to verify the authorization of the client to request the mobile location. For example, client database 301 can be used to determine if the client is an employer and if the telephone number of the mobile station whose location is to be found is the telephone number of one of his/her employees. The employer can be identified by the originating telephone number of the requester, a PIN (personal identification number) or both.

If the client database indicates that the client is authorized to request the location then the processor sends a message via interface 307 to the wireless network. The wireless network will respond with identification data in the format of the particular country, vendor, carrier, and region of the switch in which the target mobile station is found. This return message is then passed by the processor 303 to interface 305 to request a location from the centralized database 101. When this information is received in interface 305, it is passed by processor 303 to interface 309 to inform the clients.

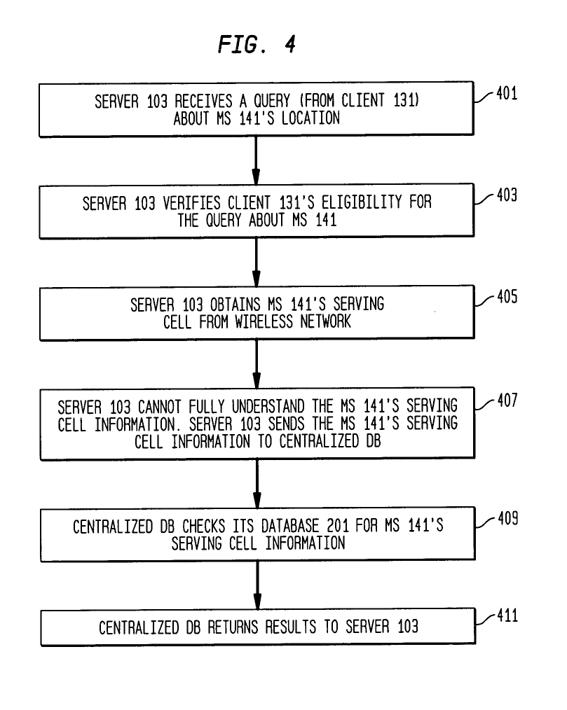

FIG. 4 is a flow diagram illustrating the operation of Applicants' invention. A server receives a query from a client to identify the location of mobile station 141 (action block 401). The server verifies the client's eligibility to request the location of target mobile station X (action block 403). Prior art authorization and authentication schemes, using, for example, an automatic number identification (ANI) or a personal identification number (PIN) are adequate for the verification. The server obtains the mobile station's serving base station and sector identification information from the wireless network (action block 405). The server 103 passes the serving base station and sector information received from the wireless network to the centralized database (action block 407). The centralized database translates between the serving base station and sector information received from the server and the geographic location of the mobile station (action block 409). The centralized database returns this information to the server (action block 411) which passes it on to the client.

In accordance with the ANSI-41 Standard, the cell and sector identification information consists of the sets of double octet entities. The first set is a location area identifier. The second set is a serving cell identifier and the last set is a target cell identifier. No target cell identifier is needed if the mobile station is not being handed off. The location area identifier identifies the cell and sector in which the mobile station is currently found. The serving cell identifier also identifies the cell and sector in which the mobile station is currently found. For the case in which a mobile station is being handed off between one cell and sector and a second cell and sector, the target cell identification is used to identify the cell and sector to which the mobile station is being handed off. For some vendors, such as all vendors providing systems to China, the base station identification consists of the 8 bits of the first byte and 4 bits of the second byte, the other 4 being used for a sector identification; for other countries and other vendors, the first byte contains 4 bits of the base station identification and 4 bits to identify the sector while the second byte contains the other 8 bits of the base station identification. This layout has not been standardized. The database is required to perform the translation from a varied format and data for identifying the format, and to perform the translation from the identification of the base station and sector to a geographic location.

The above description is of one preferred embodiment of Applicants' invention. Other embodiments will be apparent to those of ordinary skill in the art without departing from the scope of the invention. The invention is only limited by the attached claims.

We claim:

1. In a mobile telecommunications network, a method of determining an approximate location of a mobile station, comprising the steps of:
sending a request to said mobile telecommunications network to determine a location of a target mobile station;
responsive to receipt of said request, said mobile telecommunications network identifying a base station and sector currently serving said mobile station;
said mobile telecommunications network transmitting data for identifying said base station and sector, and data for identifying at least one of a country, a vendor, a region, and a service provider of that base station;
in a database, translating between said data for identifying said base station and sector, and said data for identifying at least one of a country, a vendor, a region, and a service provider of said base station to obtain identification in a standard format of said base station and sector; and
translating from said identification in a standard format of said base station and sector to a geographic location of said base station and sector.

2. The method of claim 1 further comprising the step of:
authenticating whether said request comes from a source authorized to make the request.

3. The method of claim 1 wherein said data for identifying at least one of a country, a vendor, a region and a service provider consists of data for identifying a country.

4. The method of claim 1 wherein said data for identifying at least one of a country, a vendor, a region and a service provider consists of data for identifying a service provider.

5. The method of claim 1 wherein said data for identifying at least one of a country, a vendor, a region and a service provider consists of data for identifying a vendor.

6. The method of claim 1 wherein said data for identifying at least one of a country, a vendor, a region and a service provider consists of data for identifying a country and region.

7. The method of claim 1 wherein said data for identifying at least one of a country, a vendor, a region and a service provider consists of data for identifying a region.

8. In a mobile telecommunications network, apparatus for determining an approximate location of a mobile station, comprising:
apparatus for sending a request to said mobile telecommunications network to determine a location of a target mobile station;
said mobile telecommunications network comprising apparatus, responsive to receipt of said request, for identifying a base station and sector currently serving said mobile station;
said mobile telecommunications network comprising apparatus for transmitting data for identifying said base station and sector, and said data for identifying at least one of a country, a vendor, a region, and a service provider of that base station;
in a database, apparatus for translating between said data for identifying said base station and sector, and said data for identifying at least one of a country, a vendor, a region, and a service provider of said base station to obtain identification in a standard format of said base station and sector; and
apparatus for translating from said identification in a standard format of said base station and sector to a geographic location of said base station and sector.

9. The apparatus of claim 8 further comprising apparatus for:
authenticating whether said request comes from a source authorized to make the request.

10. The apparatus of claim 8 wherein said data for identifying at least one of a country, a vendor, a region and a service provider consists of data for identifying a country.

11. The apparatus of claim 8 wherein said data for identifying at least one of a country, a vendor, a region and a service provider consists of data for identifying a service provider.

12. The apparatus of claim 8 wherein said data for identifying at least one of a country, a vendor, a region and a service provider consists of data for identifying a vendor.

13. The apparatus of claim 8 wherein said data for identifying at least one of a country, a vendor, a region and a service provider consists of data for identifying a country and a region.

14. The apparatus of clam 8 wherein said data for identifying at least one of a country, a vendor, a region and a service provider consists of data for identifying a region.
